(19) United States
(12) Patent Application Publication
(10) Pub. No.: US 2013/0106303 A1
(43) Pub. Date: May 2, 2013

(54) DIMMING CONTROL METHOD AND APPARATUS

(71) Applicant: JUI-CHIH YEN, Taipei City (TW)

(72) Inventor: JUI-CHIH YEN, Taipei City (TW)

(21) Appl. No.: 13/282,663

(22) Filed: Oct. 27, 2011

(51) Int. Cl. H05B 37/02

(52) U.S. Cl. 315/206

(57) ABSTRACT

A phase comparator is connected between a rectifier and an oscillator in the primary side of the transformer of lighting equipment. The phase comparator obtains rectifier's frequency multiplication signal of pulse DC signal as a reference phase and a phase synchronization signal of a phase angle θ of the AC power signal then transmits to the control of the oscillator, and synchronizes the oscillation frequency of the oscillator and phase synchronization signal with the phase angle θ of rectifier, to avoid flickering of phase adjustment of AC power by TRAIC.

### BACKGROUND OF THE INVENTION

1. Field of the Invention

The present invention relates to a dimming control method and an apparatus thereof, in particular to a dimming control method and an apparatus for lighting equipment having LED or CCFL as light source without flickering.

2. Description of the Related Art

Heretofore, energy saving and ban of incandescent lamp is a global trend. LED (light emitting diode) with advantages such as high efficiency, energy saving, and dimmable capability has already become a better choice in lighting market, in street lamp, automobile lamp, outdoors lighting and scenic lighting application, LED is the focus.

Dimmers are often applied to adjust brightness in traditional lighting application, TRIAC (Tri-electrode AC switch) varies voltage by variable resistor to adjust brightness of light sources, such as halogen or tungsten lamps, therefore dimmers and lighting equipment can be installed separately (dimmer is on wall), users can adjust brightness conveniently.

The lamp drivers of LED or CCFL light sources is to convert AC power into low voltage DC by transformer for LED or DC to AC inverter for CCFL. The electrical characteristic of LED driver is capacitive, to control the brightness through traditional dimmer, flickering happens for wave is divided and not be able to synchronize with TRIAC.

A LED dimmer in the market converts AC grid power into AC dimmable power through TRAIC and transformer, then have the voltage multiplier unit in the driver multiple AC power voltage, convert to DC power within the driving range of LED working voltage to drive LED without flickering. Such design is complicate in circuitry, low compatibility among lamps, manufacturing cost is higher.

### SUMMARY OF THE INVENTION

In view of the aforementioned problems of the prior art, it is a primary objective of the present invention to provide a dimming control apparatus and a method thereof, capable of dimming lighting equipment with LED or CCFL as light sources without flickering.

To achieve the foregoing objective, the present invention provides a dimming control method, is to have a phase comparator connected between rectifier and oscillator in the primary side of the transformer of a lighting equipment, the phase comparator obtains rectifier's frequency multiplication signal of pulse DC signal as a reference phase and a phase synchronization signal of a phase angle θ of the AC power signal then transmits to the control of the oscillator, and synchronizes the oscillation frequency of the oscillator and phase synchronization signal with the phase angle θ of rectifier, to avoid flickering of phase adjustment of AC power by TRAIC.

To achieve the foregoing objective, the present invention provides a dimming control apparatus comprises of a rectifier, an oscillator, a transformer and a phase comparator. The rectifier receives AC power grid sine wave and converts AC into positive sine wave pulse DC signals; the oscillator outputs power conductive period signal based on pulse DC signals received from rectifier; the transformer receives voltage signals and outputs corresponding voltage to lighting equipment. the phase comparator obtains rectifier's frequency multiplication signal of pulse DC signal as a reference phase and a phase synchronization signal of a phase angle θ of the AC power signal then transmits to the control of the oscillator, and synchronizes the oscillation frequency of the oscillator and phase synchronization signal with the phase angle θ of rectifier, to avoid flickering of phase adjustment of AC power by TRAIC.

The present invention has following effects:

1. To solve flickering problem having LED or CCFL as light source and dimming by TRAIC.

2. To have TRAIC dim lighting equipment at AC power side that simplifies dimming circuitry and manufacturing cost.

3. To have TRAIC dim lighting equipment at AC power side that increases compatibility among lighting equipment.

### BRIEF DESCRIPTION OF THE DRAWINGS

FIG. 1 is a block diagram of a dimming control apparatus of the present invention;

FIG. 2 is a schematic view of a comparator of a dimming control apparatus in accordance with a preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

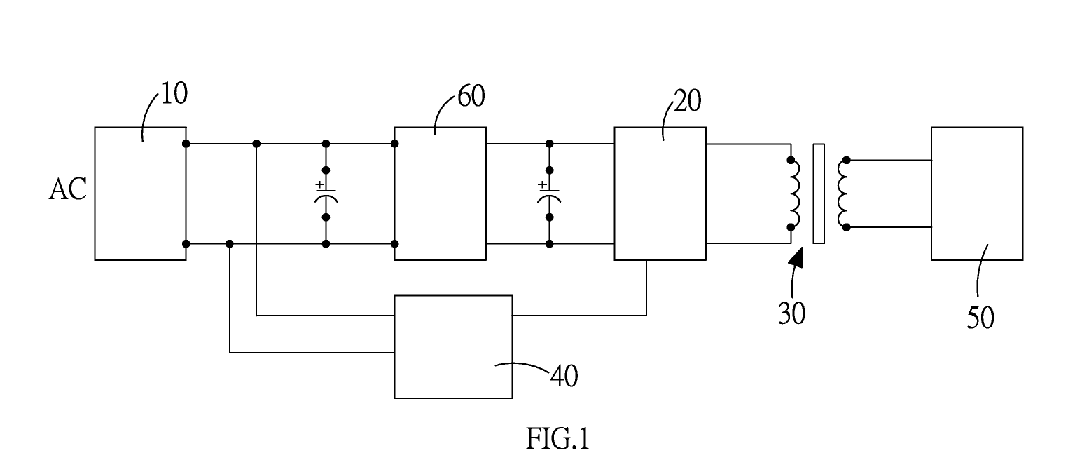

With reference to FIG. 1 for a block diagram of a dimming control method of the present invention comprises a phase comparator 40 connected between a rectifier 10 and an oscillator 20 in the primary side of the transformer 30, the phase comparator 40 obtains rectifier's 10 frequency multiplication signal of pulse DC signal as a reference phase and a phase synchronization signal of a phase angle θ of the AC power signal then transmits to the control of the oscillator 20, and synchronizes the oscillation frequency of the oscillator 20 and phase synchronization signal with the phase angle θ of rectifier 10, to avoid flickering of phase adjustment of AC power by TRAIC.

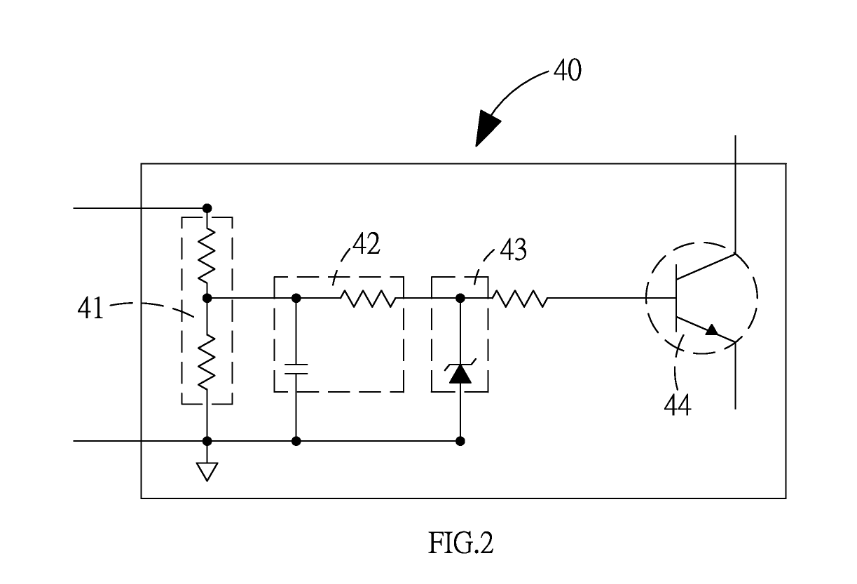

With reference to FIG. 2, a dimming control apparatus of the present invention comprises a rectifier 10, an oscillator 20, a transformer 30 and a phase comparator 40.

The rectifier 10 gets AC grid sine wave power and converts AC into positive sine wave pulse DC signals. The oscillator 20 outputs power conductive period signal based on pulse DC signals received from rectifier 10. The transformer 30 receives voltage signals and outputs corresponding voltage to light sources 50 of lighting equipment, the light sources 50 are LED or CCFL.

the phase comparator 40 obtains rectifier's 10 frequency multiplication signal of pulse DC signal as a reference phase and a phase synchronization signal of a phase angle θ of the AC power signal then transmits to the control of the oscillator 20, and synchronizes the oscillation frequency of the oscillator 20 and phase synchronization signal with the phase angle θ of rectifier 10, to avoid flickering of phase adjustment of AC power by TRAIC. A Power Factor Correction unit 60 (PFC) is installed between the rectifier 10 and the oscillator 20 to lift the power utilization rate.

In the preferred embodiment, the phase comparator 40 further consists of a bias circuitry 41, a filtering circuitry 42, a clamp circuitry 43 and a switch 44.

The bias circuitry 41 gets rectifier's 10 frequency of frequency multiplication of DC pulse signal as reference phase; the filtering circuitry 42 lowers noise level of the frequency multiplication signals; the clamp circuitry 43 limits the voltage level of frequency multiplication signals between 5-10V.

The switch 44 is one of following components: transistor, MOSFET or OPAMP comparator, in this preferred embodiment the switch 44 is transistor; when the frequency multiplication signals is low, transistor is open and non-conductive, when frequency multiplication signals is high, transistor is close and conductive, and has oscillator 20 oscillates to have the frequency of the oscillator 20 and frequency multiplication signals phase θ output by rectifier 10 in synchronization.

Compare to traditional technologies, the present invention solves flickering problem to have LED or CCFL as light sources of lighting equipment and dim of phase adjustment of AC power by TRAIC; to have TRAIC dim lighting equipment at AC power side simplifies dimming circuitry and manufacturing cost, also increases compatibility among lighting equipment.

While a preferred embodiment of the invention has been shown and described in detail, it will be readily understood and appreciated that numerous omissions, changes and additions may be made without departing from the spirit and scope of the invention.

What is claimed is:

1. A dimming control method, comprising a phase comparator connected between a rectifier and an oscillator in the primary side of the transformer, said phase comparator obtains said rectifier's 10 frequency multiplication signal of pulse DC signal as a reference phase and a phase synchronization signal of a phase angle θ of the AC power signal then transmits to the control of said oscillator, and synchronizes the oscillation frequency of said oscillator and phase synchronization signal with the phase angle θ of said rectifier, to avoid flickering of phase adjustment of AC power by TRAIC.

2. A dimming control apparatus comprising:
a rectifier gets AC power grid sine wave and converts AC into positive sine wave pulse DC signals;
an oscillator outputs power conductive period signal based on pulse DC signals received from said rectifier;
a transformer receives voltage signals and outputs corresponding voltage to light sources of lighting equipment;
a the phase comparator obtains said rectifier's frequency multiplication signal of pulse DC signal as a reference phase and a phase synchronization signal of a phase angle θ of the AC power signal then transmits to the control of said oscillator, and synchronizes the oscillation frequency of said oscillator and phase synchronization signal with the phase angle θ of said rectifier.

3. The dimming control apparatus of claim 2, wherein said phase comparator further comprises:
a bias circuitry gets said rectifier's frequency of frequency multiplication of DC pulse signal as reference phase;
a filtering circuitry lowers noise level of the frequency multiplication signals;
a clamp circuitry limits the voltage level of frequency multiplication signals; and
a switch, when the frequency multiplication signals is low, said switch is open and non-conductive, when frequency multiplication signals is high, said switch is close and conductive, and has said oscillator oscillates to have the frequency of the oscillator 20 and frequency multiplication signals phase θ output by rectifier 10 in synchronization.

4. The dimming control apparatus of claim 3, wherein said is one of transistor, MOSFET or OP comparator.

5. The dimming control apparatus of claim 2, wherein said rectifier and said oscillator connect to a Power Factor Correction (PFC) unit.
